(19) United States
(12) Patent Application Publication
(10) Pub. No.: US 2007/0244720 A1
(43) Pub. Date: Oct. 18, 2007

(54) Future care plan costing system and method

(75) Inventor: William F. Walker, Huntsville, AL (US)

Correspondence Address: LANIER FORD SHAVER & PAYNE P.C., P O BOX 2087, HUNTSVILLE, AL, 35804, US

(73) Assignee: SaddlePoint Software, LLC, Huntsville, AL (US)

(21) Appl. No.: 11/405,081

(22) Filed: Apr. 17, 2006

(51) Int. Cl. G06Q 10/00

(52) U.S. Cl. 705/2

(57) ABSTRACT

A system and method for creating and costing future care plans such as Life Care Plans, Medicare Set-Asides, and Medical Cost Projections is provided. The method uses standard procedure codes and fee schedules associated with the procedure codes. The method comprises storing a first code set in a database, receiving a second code set associated with a future care plan, in which the second code set is a subset of the first code set; comparing the first code set with the second code set to determine the common codes; associating the applicable fee from the fee schedule with each individual code; and generating an output file comprising the second code set with associated fees. The method also provides the capability of billing users based upon the number and nature of individual fee codes retrieved using the method.

### BACKGROUND

1. Field of the Invention

The present invention relates generally to a method for creating cost projections. More specifically, this invention relates to a method for creating cost projections for future care plans such as Life Care Plans, Medicare Set-Asides, and Worker's Compensation Medical Cost Projections.

2. Background of the Invention

The creation of individual-specific health care cost projections is necessary in several different business sectors and applications. In the litigation arena, Life Care Planning is used to identify the needs of individuals who have experienced catastrophic injury or have chronic health needs. Life Care Planning allows adjusters and attorneys working with disabled individuals to plan for the future with the knowledge of when and how the expenditures for care will be allocated, allowing for financial planning and the setting of reserves from provider sources. Life Care Planners generate Life Care Plans using published standards of practice, comprehensive assessment, and data analysis and research, and provide an organized, concise plan for current and future needs, with associated costs projected annually or over the individual's life expectancy. Life Care Plans are organized in an easy to read table format and provide information in present day costs including the care needs and frequency through the life span for the areas including but not limited to evaluations, diagnostic tests, routine medical care, aggressive medical care, medications, therapy, equipment and supplies, orthotics and prosthetics, education, vocation, transportation, home renovations, home care and facility care.

Costs associated with a Life Care Plan have in the past been typically obtained by contact with the vendors possibly supplying the item to the Life Care Plan recipient, i.e., medical professionals, equipment suppliers, etc. A standard of practice for a Life Care Planner is to contact three (3) vendors for an item and obtain pricing for the item, sum and average the prices, and use the average cost per year value of the item as the price in the Life Care Plan. Optionally, a range of prices (high, low) can be used as well. In recent times, Life Care Planners have been gradually moving toward the use of the standardized coding system used in Medicare Set-Asides, as is discussed in detail below.

In the Worker's Compensation arena, and for injuries compensable through workers' compensation, the analogous future care plan is the Medicare Set-Aside. Worker's Compensation insurance carriers are required to consider and protect the interests of Medicare when resolving Worker's Compensation cases that include future medical expenses. In order to protect Medicare's interests, an appropriate amount of money from a settlement of a Worker's Compensation injury must be “set-aside” for the payment of future medical costs that would otherwise be Medicare compensable. A Medicare Set-Aside can be thought of as a specialized Life Care Plan, because Medicare will approve only a subset of the items that can be included in a Life Care Plan. Once the approved set-aside amount is exhausted and accurately accounted for, Medicare will agree to pay primary for future Medicare covered expenses related to the Worker's Compensation injury.

Medicare billing is based on two sets of codes, the diagnosis code and the procedure code. The diagnosis code represents the diagnosed illness or malady or in some cases just the fact that the patient is having a routine checkup. The diagnosis codes used by Medicare are International Classification of Diseases codes (“ICD-9”), and are used to describe known conditions, diseases and injuries. The procedure code represents the procedure being ordered and is associated with the diagnosis code on the basis of medical necessity. In other words, each diagnosis code has a set of related procedures that can be ordered. There are two types of procedure codes that can be used by a health care provider to specify the procedures ordered, and these codes are also used by future care planners. The first type of codes is the Common Procedural Terminology, or CPT code. The second type is Health Care Procedural Coding System (“HCPCS”). In addition, many inpatient hospital services are described by Diagnosis Related Group (“DRGs) codes. These codes can also be used by future care planners.

Typically, all items used within a Medicare Set-Aside are either “Medicare Allowable” or “Medicare Non-Allowable.” All of the allowable items are contained within the Medicare Fee Schedule and all are described by one of the codes. Pricing for these items are usually obtained from the Worker's Compensation Fee Schedule for the applicable state for the injured worker, although a minority of states have different pricing structures, such as using the “usual and customary charge” for the item plus or minus a percentage. For example, the State of Alabama has an established fee schedule for each CPT or HCPCS code.

Although Life Care Planners are not required to use the codes or Worker's Compensation Fee Schedules required by Medicare (i.e., ICD-9, CPT, DRG, and HCPCS codes), doing so provides certain advantages, and is a thus a growing preference by Life Care Planners.

A less formal tool applicable to the Worker's Compensation sector is a Worker's Compensation Medical Cost Projection, which is usually an internal plan created by a Worker's Compensation insurance carrier or case management company, to calculate funds that will be needed in the future in their Worker's Compensation injury cases. A Medical Cost Projection does not have to be as detailed as a Life Care Plan or Medicare Set-Aside because a Medical Cost Projection is typically an internal document. Typically, most of the items in a Medical Cost Projection are obtained from the applicable state Worker's Compensation Fee Schedule, although some items contained within may not be in the fee schedule for the state.

Life Care Plans, Medicare Set-Asides, and Medical Cost Projections are three specific variations on the theme of creating a future plan of treatment for an injured individual, including the frequencies of proposed care or equipment used in the plans, the types of providers or suppliers of the treatment or equipment, a schedule of the future times the treatments or equipment will need to be purchased or provided to the injured individual, and anticipated prices for the items and yearly costs. In this specification, Life Care Plans, Medicare Set-Asides, and Medical Cost Projections are referred to generally as “future care plans.”

In all of these future care plans, the first step is performed by a planner who creates a future plan of treatment for an injured individual, including providing options where alternative courses of action are available. An example of a plan with two options would be one that includes both the options of stay-at-home care and nursing home care. A plan will typically have from none to three (3) options, although more options are possible.

The planner inputs items into the plans according to categories associated with each item and options available within the plan. Typically, the printed output of the future care plan will included a tabulated schedule which includes the items in the plan, frequencies of replacement for the items, cost per year of the items and the dates the items will be needed, sorted by category and option. Also included in a typical plan will a summary of costs associated with the tabulated portion; these summaries are usually one or all of three typical styles: A summary of average yearly costs, a summary of ranged yearly costs, and a “roll-up summary,” which is a summary subtotaled by categories only. Summaries also have a grand total of costs.

In the past, future plans of treatment were created manually, and then the planner would look up the codes on the applicable state fee schedule, if applicable, to apply costs to the plan. There are now software tools available to assist planners in their preparation. Various software programs provide electronic listing of all possible diagnosis and procedure codes and items associated with various procedures, such as wheelchairs and accessories, so that the codes and items can be chosen from menus and input into an electronic plan. However, planners are still required to separately reference and research multiple sources to appropriately price the individual items in the future care plan.

It would therefore be desirable to provide Worker's Compensation fee schedules and other applicable pricing information from all available states and convert them to a common database format.

It would also be desirable to provide only the specific pricing information needed by future care planners rather than all of the fee schedules and pricing information.

It would also be desirable to charge future care planners for access to such specific pricing information based upon how many priced items are retrieved from the common database.

### SUMMARY OF THE INVENTION

Therefore, the primary objective of this invention is to provide a system and method for creating and costing future care plans such as Life Care Plans, Medicare Set-Asides, and Medical Cost Projections using state Worker's Compensation fee schedules and similar standard pricing databases. For convenience, the pricing databases will be referred to as “Worker's Compensation Fee Schedules.”

Another object of the invention is to provide a method for creating future care plans in which users are charged based upon the number and nature of the costed items retrieved.

The fee schedules for the different states are currently presented in a variety of formats, ranging from delimited text files, to .pdf files, to paper form. To facilitate the invention herein, the applicant converts the schedules into a common database structure. Once converted, the fee schedule for a particular state can be used to furnish data to the creators of future care plans such as Life Care Plans, Medicare Set-Asides, and Medical Cost Projections for individuals subject to the laws of that particular state, making the item available to users on a per-item basis.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements.

FIG. 1 depicts an embodiment of a method according to the present invention.

FIG. 2 is a block diagram of the steps performed by users in generating a future care plan with codes.

FIG. 3 depicts a sample computer screen showing the future care plan item choices available to the planner.

FIG. 4 depicts a sample computer screen showing example CPT codes available to the planner.

FIG. 5 depicts a sample computer screen showing example HCPCS codes available to the planner.

FIG. 6 illustrates the method by which the priced and unpriced code items are generated.

FIG. 7 illustrates the components of an embodiment of a system according to the present invention.

FIG. 8 is an excerpt from a Medicare Set-Aside generated using the system and process of the present invention and showing priced codes.

FIG. 9 is an excerpt of a future care plan in which the results are provided in a cost-by-item by year format.

FIG. 10 is an excerpt of a future care plan providing a future value/reduction to present value analysis.

### DETAILED DESCRIPTION OF THE ILLUSTRATED EMBODIMENT

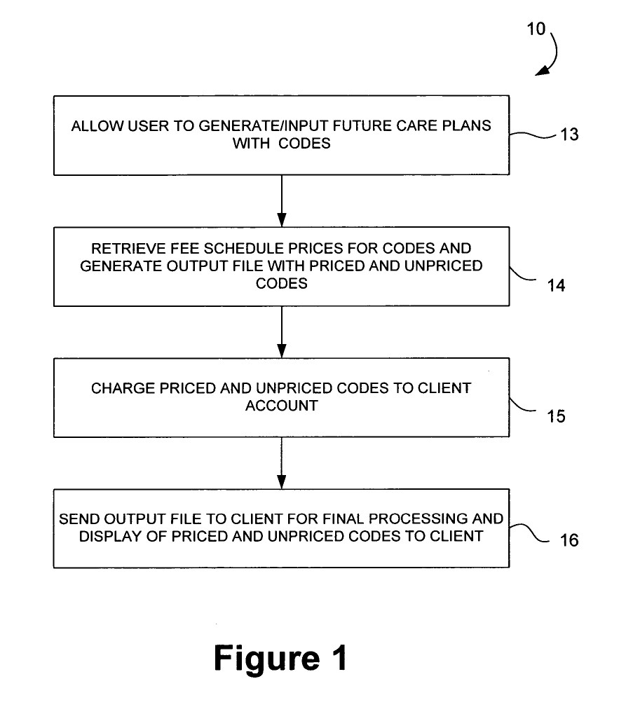

The present invention and its advantages are best understood by referring to the drawings. In the preferred embodiment, a method for creating a future care plan using automated code pricing and providing the priced codes to users in an automated fashion is depicted in FIG. 1. The method comprises several steps to implement a system for delivering personalized future care data to users over a network to a user terminal device of the user's selection.

To implement the preferred method, the Worker's Compensation Fee Schedule information from a plurality of states has already been loaded into a database system. The information input into the database comprises the state pricing schedules for items by CPT code, HCPCS code, and DRG code, where applicable. For states in which no fee schedules are available, this information (i.e., the fact that there is no fee schedule) will also be input into the database. The fee schedule information that is input is converted to a common database format, for example, into a Microsoft Access database. The resultant data is a pool of priced codes retrievable by item for each available and applicable state of the United States.

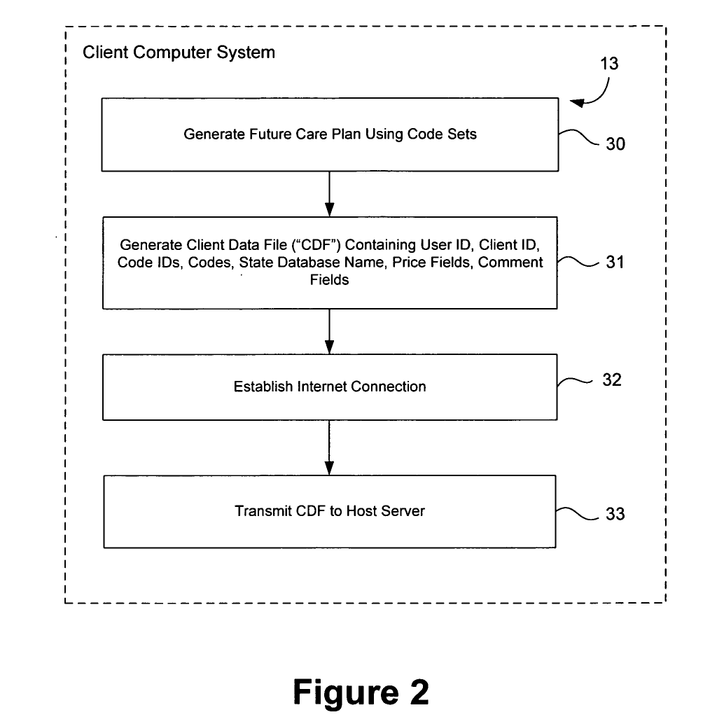

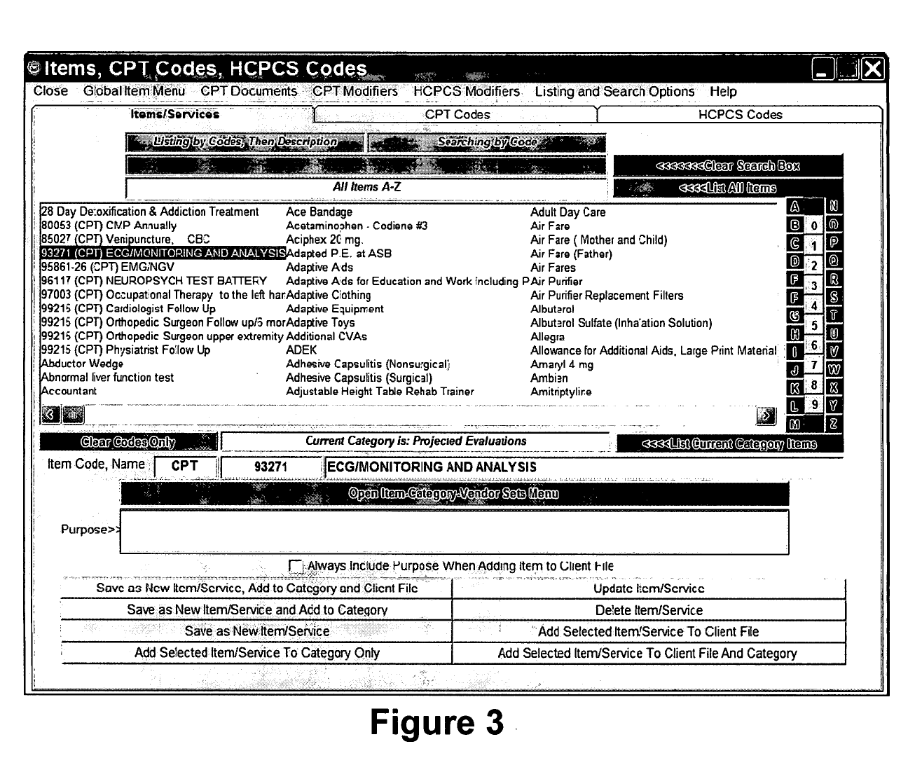

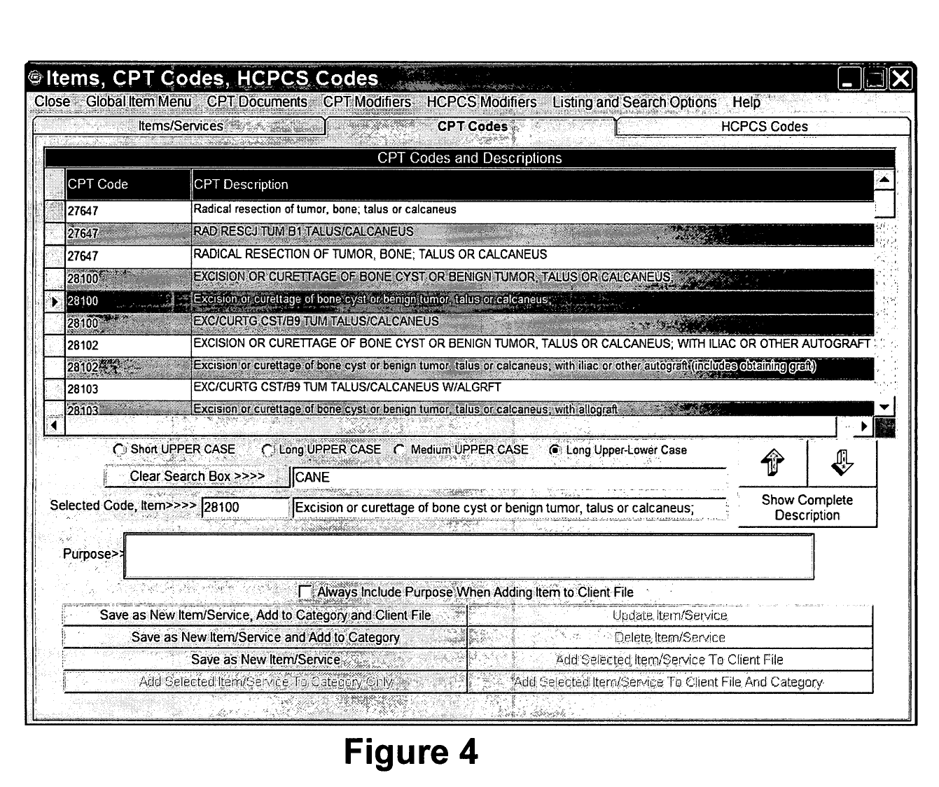

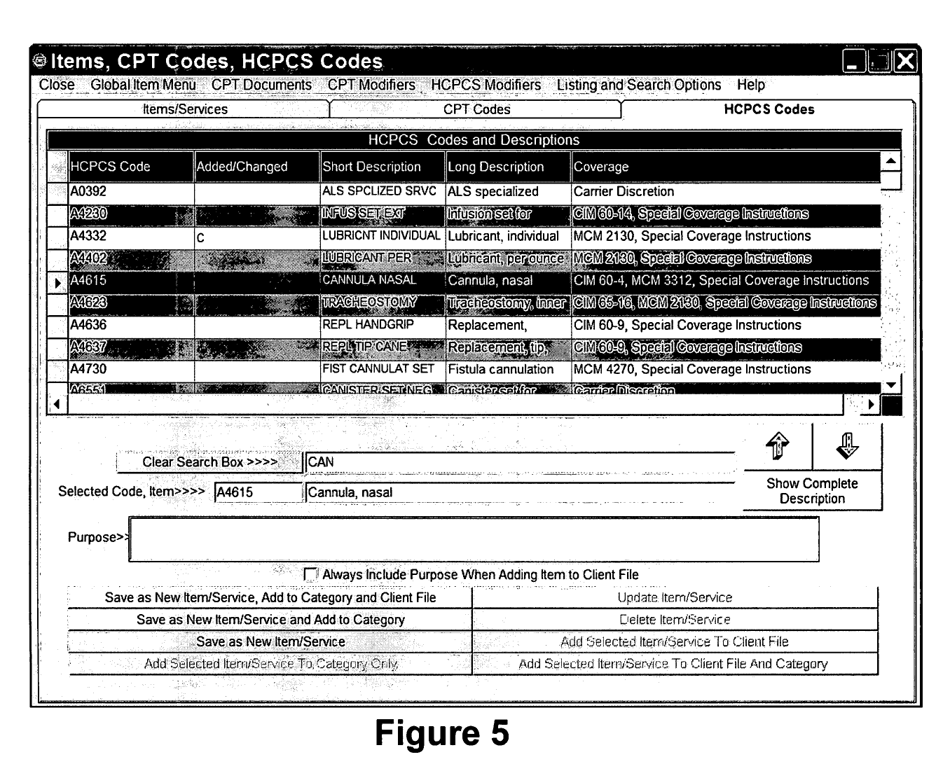

In step 13, future care plan users may create their future care plans having ICD codes, CPT codes, DRG codes, and/or HCPCS codes. (The ICD codes, CPT codes, DRG codes, HCPCS codes and/or any other generic nomenclature for various treatments or procedures, are referred to herein as “code sets.”) FIG. 2 provides further detail regarding step 13. Referring to FIG. 2, step 30, the future care plan using the code sets can be generated automatically using commercially available future care plan software. The future care plan software often allows the planner to choose from a menu containing all available options and items specific to a patient's particular plan. An example of a user screen showing the item choices (including CPT codes and HCPCS codes, among other items) available for a sample healthcare option is provided in FIG. 3. An example of a user screen showing a menu of sample CPT codes is provided in FIG. 4, and an example of a user screen showing a menu of sample HCPCS codes is provided in FIG. 5.

Referring to FIG. 2, in one embodiment of the invention, in step 31, the user's computer system generates a Client Data File (“CDF”) containing the user's identification number and client name, the code set identification, the applicable codes, the name of the state database, and blank price fields and comment fields that will be filled at a later stage. In this embodiment, in step 32, the user's computer system establishes an internet connection with the host server, and, in step 33, transmits the CDF to the host server via the internet.

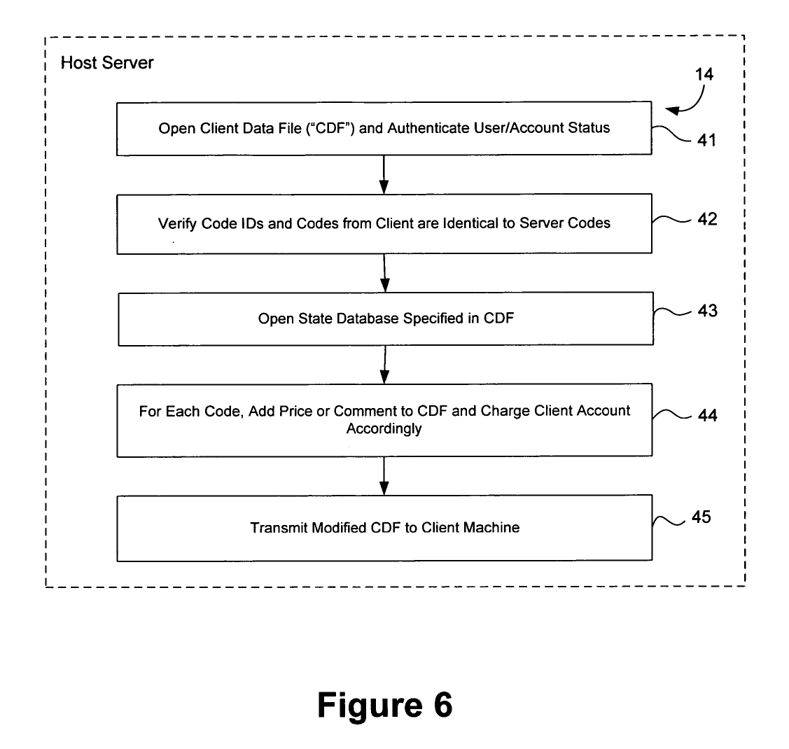

Referring now to FIG. 1, in the preferred embodiment in step 14, the host server retrieves the fee schedule prices associated with each code for the designated state and provides the priced codes to the user in an output file. One embodiment of this step is further described in FIG. 6. Referring to FIG. 6 step 41, first, the server software opens the data file and establishes the user's identity and account status (i.e., verifies that the client has credit in the account and has download privileges). If the client is not an approved client or there is a problem with the client's account, then an error message will be generated and sent back to client-side software to be displayed on client machine, explaining the nature of error.

In this embodiment, per step 42, after the client and client account are verified, then server-side software will compare codes and code identification numbers contained in the Client Data File with those in the server-side database. If the codes and code identification numbers are identical, then the server-side software will proceed; if not, an error message that details discrepancies found will be generated and sent back to client-side software to be displayed on the client machine. The client then has the option to correct discrepancies and retransmit the data file.

Next in this embodiment, per step 43, the server-side software will then open the particular state database specified in the Client Data File. Then, in step 44, the software will then loop through the codes in the Client Data File one by one and compare them with the state database. If the code price is contained within the state database, the software will insert the prices contained within the state database into the Client Data File. If the state database does not contain the pricing, the server-side software will insert a comment in the Client Data File stating the pricing was not found within the database. Per step 45, once all the codes are examined and either priced or commented in the Client Data File and on the server, the server-side software will save, close and transmit the modified database file back to the client's computer.

Referring to FIG. 1, in the preferred embodiment, step 15, the user's account is charged for the priced and unpriced codes retrieved based on the number of codes provided to the user and whether they are priced or unpriced. The unpriced codes will typically be charged at a lower rate than the priced codes.

In the preferred embodiment, step 16, the client software will open the modified Client Data File, loop through the codes in the same manner as described in the server-side process, and insert the pricing in the main client-side database. A separate file will be created that contains the comments pertaining to the pricing information not found, as well as pricing information that was found and transmitted. The file is then typically saved on the client machine for viewing by the user. The user will be prompted to view the file, which will then detail the data exchange.

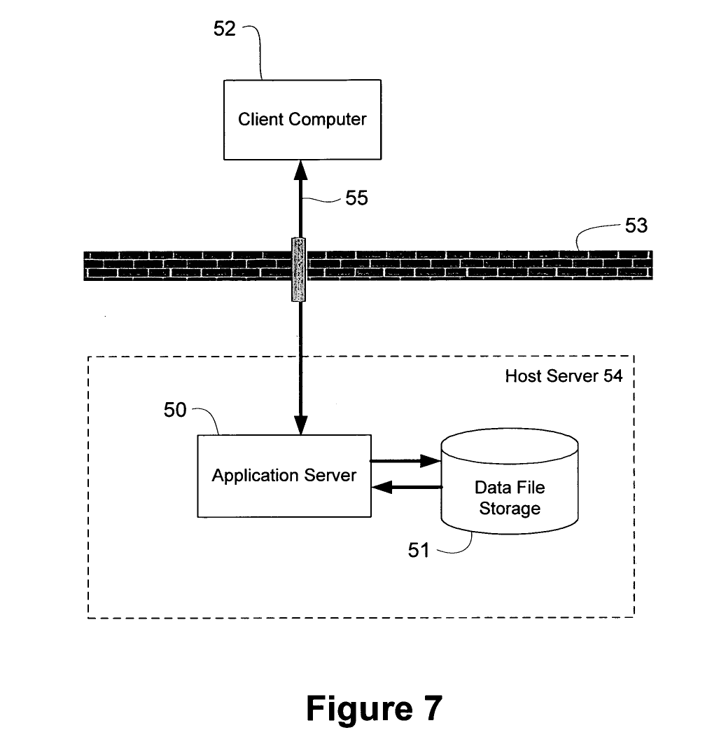

FIG. 7 is a block diagram of the architecture of one embodiment of the system showing its various components. In the process of inputting state fee schedules, dozens of files containing data are downloaded into the application server 50 and data file storage 51. The client computer system 52 may be a standard personal computer. In one embodiment, the users personal computer contains the application software of the present invention. The client computer system 52 connects to the host server 54 via the internet 55. Firewall 53 protects the resources and information stored on the host server 54.

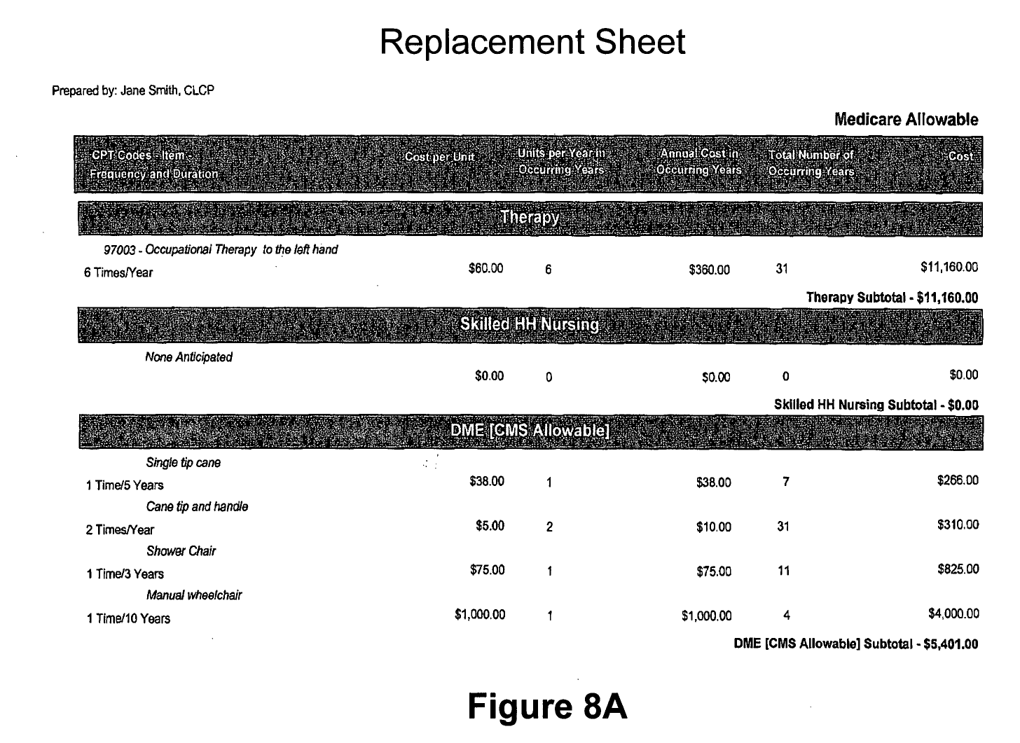

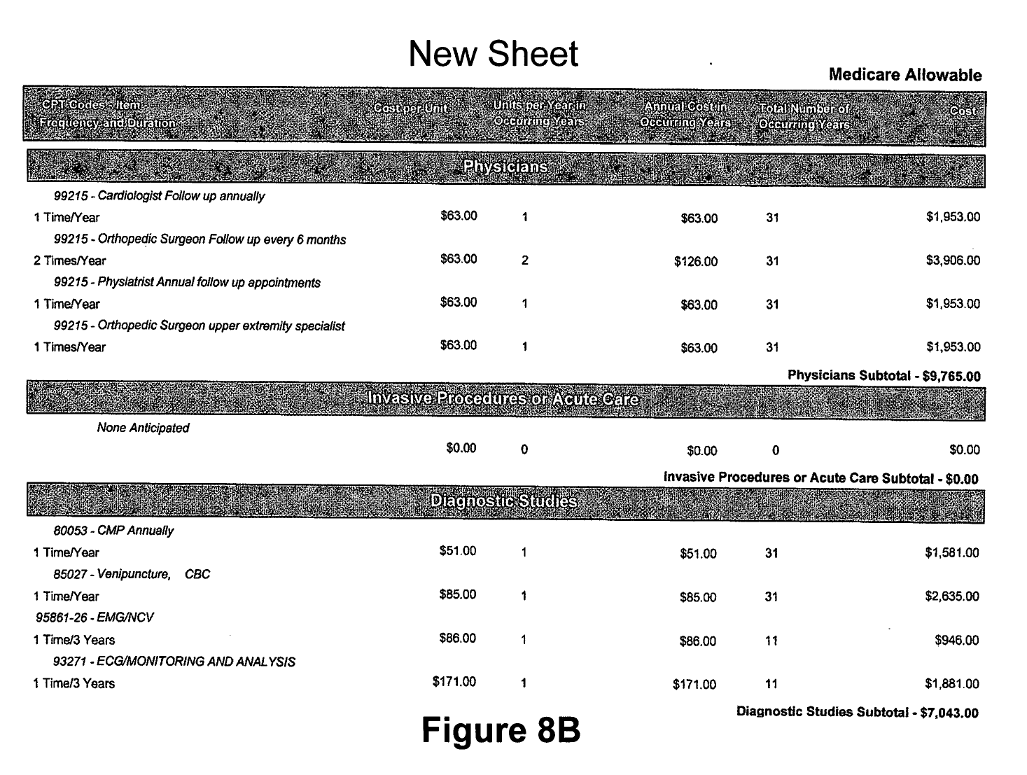

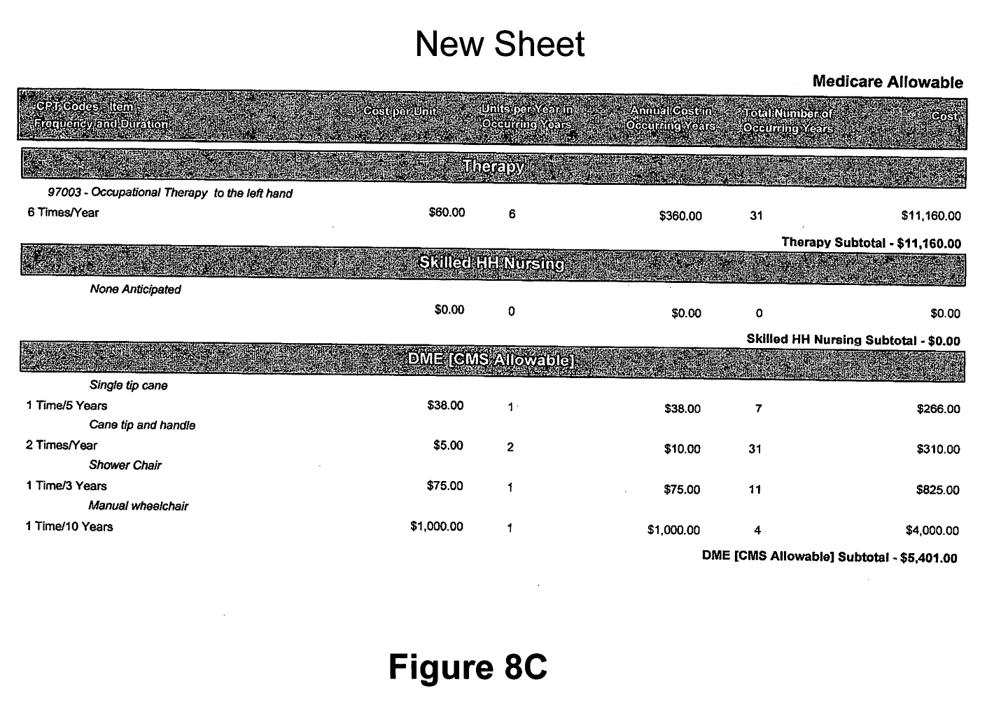

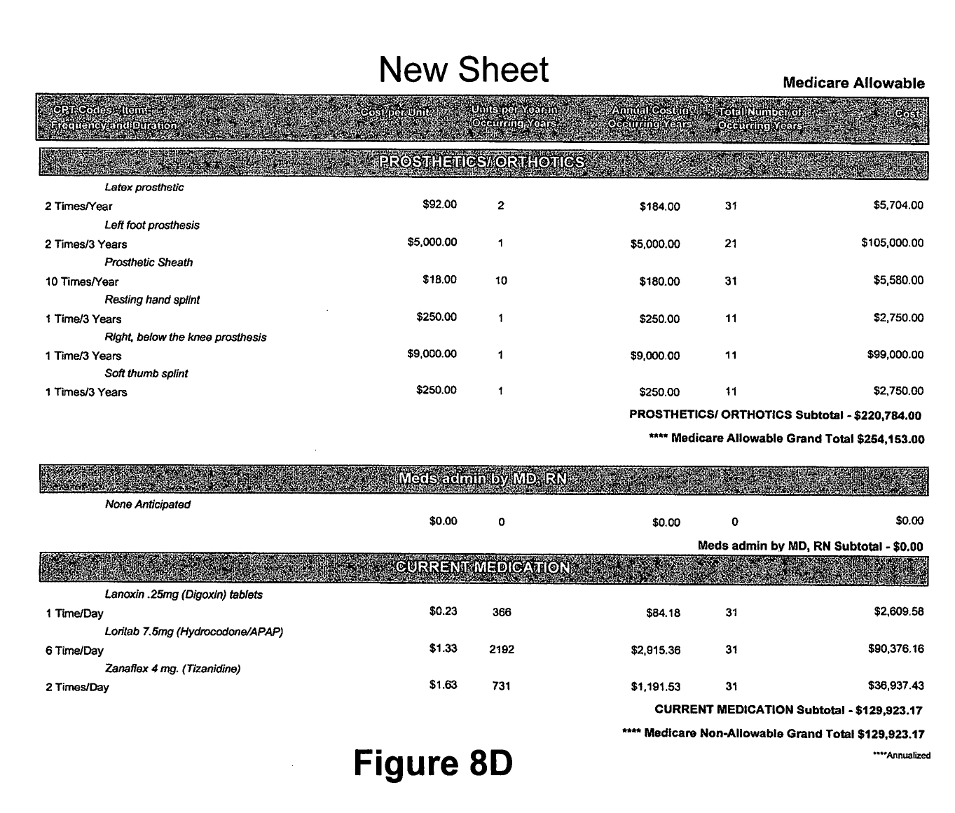

An example of an excerpt from a Medicare Set-Aside generated using the system and process of the present invention and showing priced codes is provided in FIG. 8.

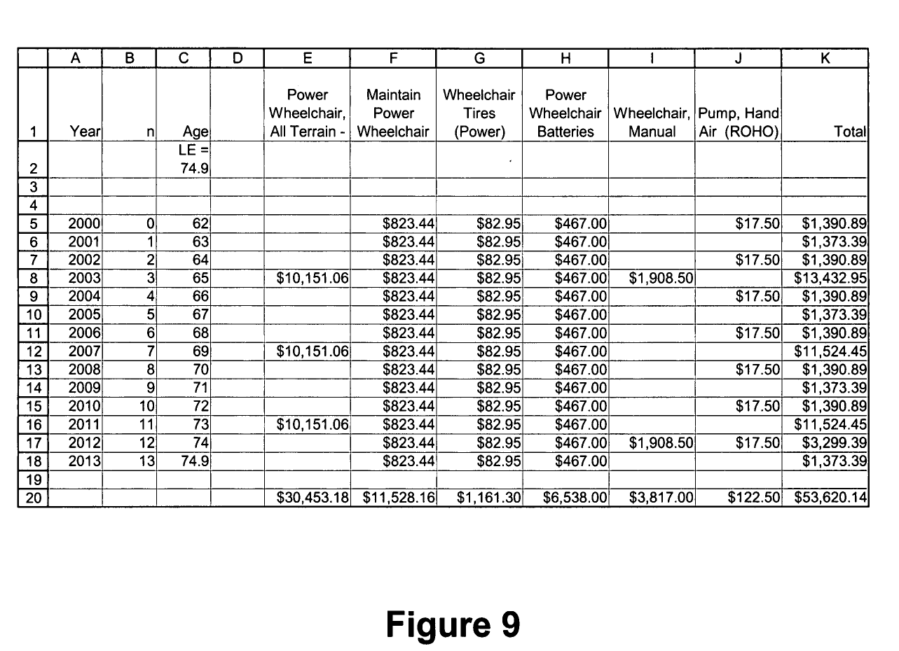

In some embodiments of the system and method disclosed herein additional flexibility and functionality in reporting the data and inputting it into a final future care plan is available. One such feature is a cost-by-item by-year analysis subtotaled by year. This function takes the items in a future care plan and groups them by item instead of by year, and provides the data to the user in a Microsoft Excel spreadsheet. An excerpt of a future care plan in which the results are provided in this fashion is included at FIG. 9.

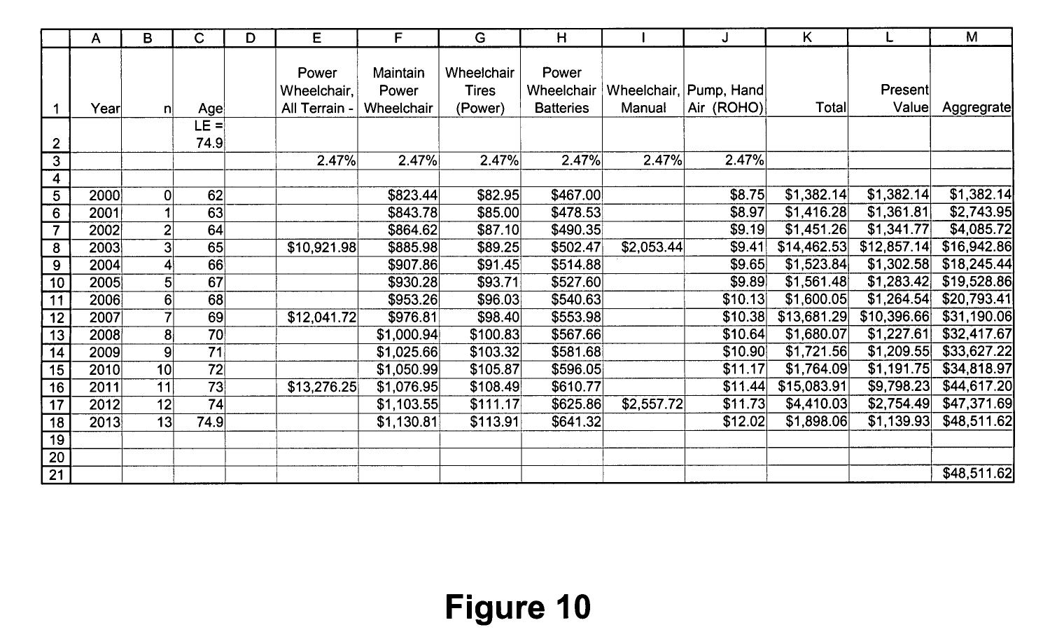

Another option in reporting the results is the provision of a future value/reduction to present value analysis, which projects the future value of the care plan and then brings it back to the present value. A sample report of a future value/present value analysis is included at FIG. 10.

This invention may be provided in other specific forms and embodiments without departing from the essential characteristics as described herein. The embodiment described is to be considered in all aspects as illustrative only and not restrictive in any manner.

As described above and shown in the associated drawings and exhibits, the present invention comprises a system and method for the creation of future care plans such as Life Care Plans, Medicare Set-Asides, and Medical Cost Projections. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A method for generating cost data for a future care plan associated with a client comprising the steps of:
a) storing one or more one fee schedules in a database, such fee schedules comprising a first code set and fees associated with each individual code in said first code set;
b) receiving a second code set associated with the future care plan for a client, said second code set being a subset of the first code set;
c) comparing the first code set with the second code set to determine the common codes;
d) associating the applicable fee from the fee schedule with each individual code determined in step (c); and
e) generating an output file comprising the second code set and the fees associated with each individual code in the second code set.

2. The method of claim 1, further comprising generating a report providing data in the form of future values reduced to present values.

3. The method of claim 1, further comprising billing a user based upon the number of individual codes in the second code set.

4. The method of claim 1, further comprising billing a user based upon the number of individual codes in the second code set for which a fee was available from the fee schedules and the number of individual codes in the second code set for which a fee was not available from the fee schedules.

5. The method of claim 1, wherein the future care plan is life care plan.

6. The method of claim 1, wherein the future care plan is a Medicare set-aside plan.

7. The method of claim 1, wherein the future care plan is a worker's compensation medical cost projection plan.

8. The method of claim 1, wherein the first code set is selected from the group of CPT codes, DRG codes, or HCPCS codes.

9. The method of claim 1, wherein the fee schedules are state-specific.

10. The method of claim 1, wherein the output file is configured so that a recipient of the output file may automatically incorporate the fees associated with each individual code in the second code set into said future care plan.

11. The method of claim 1 further comprising the step of converting the fee schedules from multiple states in various formats to a single format capable of being stored and accessed in a single database.

12. A system for generating cost data for a future care plan associated with a client comprising:
a database of one or more fee schedules having a first code set associated with specific medical procedures and fees associated with each individual code in said first code set; and
a host server configured to receive from a remote user a second code set associated with the medical diagnosis and treatments in a future care plan for a client, wherein said host server, upon receipt of said second code set, accesses the database to compare said first code set and said second code set for common codes, and for the common codes identified, the host server associates the applicable fee to each of the individual codes in said second code, and transmits said applicable fee to the remote user.

13. The system of claim 12, wherein the fee schedules are state-specific.

14. The system of claim 12, wherein the first code set is selected from the group of CPT codes, DRG codes, or HCPCS codes.

15. The system of claim 12, wherein the host server is further configured to track the number of individual codes in the second code set.

16. The system of claim 12, wherein the host server is further configured to track the number of individual codes in the second code set for which a fee was available from the fee schedules and the number of individual codes in the second code set for which a fee was not available from the fee schedules.

17. A method of generating client-specific future care plan data comprising:
a) accessing a database of procedure codes and fees associated therewith;
b) comparing said procedure codes to one or more client-specific procedure codes associated with a client-specific future care plan to identify the common codes; and
c) for common codes identified in step (b), associating with the client-specific procedure codes the associated fees derived from the database of standard procedure codes and fees associated therewith.

18. The method of claim 17, further comprising tracking and charging the user based upon the number of client-specific procedure codes associated.

19. The method of claim 17, further comprising tracking and charging the user based upon number of client-specific procedure codes for which a fee was available from the database and the number of client-specific procedure codes for which a fee was not available from the database.

20. The method of claim 17, wherein standard procedure codes are selected from the group of CPT codes, DRG codes, or HCPCS codes.
